(19) United States
(12) Patent Application Publication
(10) Pub. No.: US 2014/0141829 A1
(43) Pub. Date: May 22, 2014

(54) CONTROL METHOD AND APPARATUS

(71) Applicant: FUJITSU MOBILE COMMUNICATIONS LIMITED, Kawasaki-shi (JP)

(72) Inventor: Naritoshi SAITO, Hino (JP)

(73) Assignee: FUJITSU MOBILE COMMUNICATIONS LIMITED, Kawasaki-shi (JP)

(21) Appl. No.: 14/080,607

(22) Filed: Nov. 14, 2013

(30) Foreign Application Priority Data
Nov. 19, 2012 (JP) 2012-252886

(51) Int. Cl. H04W 52/02

(52) U.S. Cl. CPC H04W 52/0212
USPC 455/522

(57) ABSTRACT

A disclosed method includes: determining whether or not a wireless portable terminal is in a wireless communication range of a network, wherein the wireless portable terminal includes a device that includes an arithmetic unit and a volatile memory and controls communication with the network; and upon determining that the wireless portable terminal is not in a wireless communication range of the network, stopping power supply for a portion of the device in a state that a program for causing the arithmetic unit to execute a processing to search a base station or access point in the network is kept in the volatile memory.

### CROSS-REFERENCE TO RELATED APPLICATIONS

This application is based upon and claims the benefit of priority of the prior Japanese Patent Application No. 2012-252886, filed on Nov. 19, 2012, the entire contents of which are incorporated herein by reference.

### FIELD

This invention relates to a power saving technique in wireless communication control.

### BACKGROUND

A wireless terminal that will conduct data communication through a telecommunication network connects with a base station or access point that relays data to the telecommunication network.

The wireless terminal repeats an operation to search for a connectable base station or access point even in a state where the wireless terminal do not connect with it. The operation to search for a connectable base station or access point steadily consumes the power in a battery of the wireless terminal.

In order to enhance the usability of the wireless terminal that performs the data communication, it is desired that the power is supplied from the battery as long as possible. However, the aforementioned operation of the wireless terminal to search for the base station or access point is a factor that shortens a power supply period by the battery of the wireless terminal.

### SUMMARY

A method for controlling a wireless portable terminal, which relates to one mode of this invention, includes: (A) determining whether or not the wireless portable terminal is in a wireless communication range of a network, wherein the wireless portable terminal includes a device that includes an arithmetic unit and a volatile memory and controls communication with the network; and (B) upon determining that the wireless portable terminal is not in a wireless communication range of the network, stopping power supply for a portion of the device in a state that a program for causing the arithmetic unit to execute a processing to search a base station or access point in the network is kept in the volatile memory.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a schematic diagram of communication areas;

FIG. 2 is a diagram illustrating a configuration example of a communication system;

FIG. 3 is a diagram illustrating state transitions in a wireless portable terminal in a conventional art;

FIG. 4 is a diagram depicting a consumed power of a device for a second data communication method in a search mode in the conventional art;

FIG. 5 is a diagram depicting state transitions in the wireless portable terminal in the conventional art;

FIG. 6 is a diagram depicting state transitions in the wireless portable terminal in the conventional art;

FIG. 7 is a diagram illustrating an example of a consumed power of the device for the second data communication method in a search mode in this embodiment;

FIG. 8 is a diagram depicting an example of state transitions in the wireless portable terminal in this embodiment;

FIG. 9 is a diagram depicting an example of state transitions in the wireless portable terminal in this embodiment;

FIG. 10 is a diagram depicting an example of state transitions in the wireless portable terminal in this embodiment;

FIG. 11 is a diagram depicting an example of a hardware module configuration relating to communication control;

FIG. 12 is a diagram depicting an example of a software module configuration relating to communication control;

FIG. 13 is a diagram depicting a configuration example relating to a signal processing of the wireless portable terminal;

FIG. 14 is a diagram depicting a flow example of a mode control processing;

FIG. 15 is a diagram depicting a flow example of a data communication processing in the second data communication method;

FIG. 16 is a diagram depicting a flow example of a search mode processing in the second data communication method;

FIG. 17 is a diagram depicting a module example in the device for the second data communication method;

FIG. 18 is a diagram depicting a flow example of the search mode processing in the second data communication method; and

FIG. 19 is a diagram depicting a flow example of an Idle mode processing in the second data communication method.

### DESCRIPTION OF EMBODIMENTS

In this embodiment of this invention, a situation is assumed that communication systems in two communication methods exist together. The communication systems correspond to the telecommunication networks. Either communication system provides a data communication service for wireless portable terminals. In this embodiment, it is assumed that a wireless portable terminal that supports multi-modes corresponding to both communication methods is used.

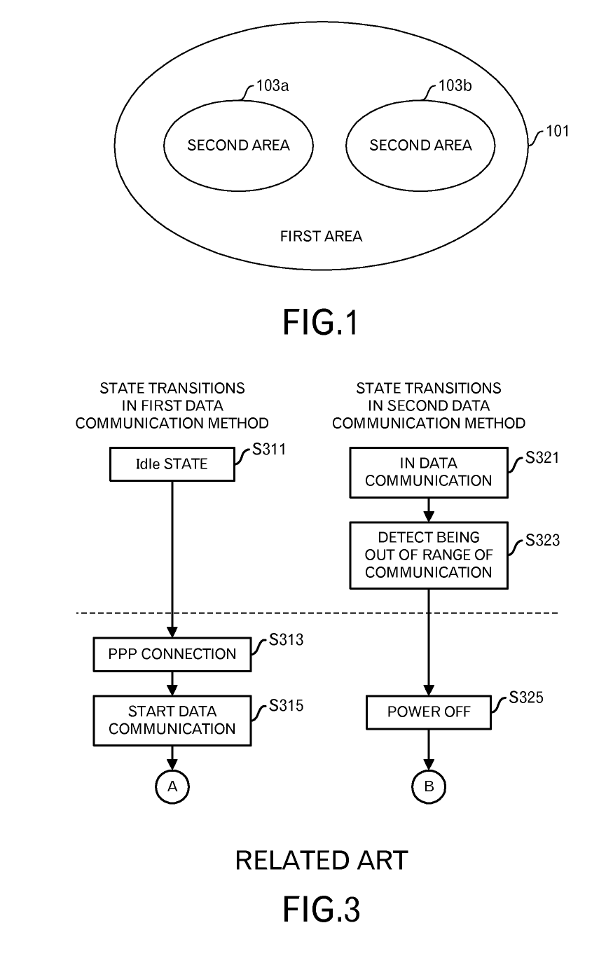

FIG. 1 schematically illustrates communication areas. A first area 101 is an area (also called communication range) in which the wireless communication in the first data communication method can be made. Second areas 103a and 103b are areas in which the wireless communication in the second data communication method can be made.

A base station included in a communication system that follows the first data communication method exists in the first area 101. The range of the first area 101 is a range in which a radio wave whose strength is equal to or greater than a predetermined strength can reach from the base station, for example.

A base station included in a communication system that follows the second data communication method exists in the second area 103 (i.e. 103a and 103b). The range of the second area 103 is a range in which a radio wave whose strength is equal to or greater than a predetermined strength can reach from the base station, for example.

In an example of FIG. 1, the big range of the first area 101 includes the small second areas 103a and 103b. In this example, because the first area 101 covers the second areas 103a and 103b, the wireless communication in both of the first data communication method and second data communication method can be performed in the second area 103a or 103b.

On the other hand, at a position that is within the first area 101 and is other than the second areas 103a and 103b, the wireless communication in the first data communication method is possible, however, the wireless communication in the second data communication method is impossible. This example illustrates an example in which two second areas 103a and 103b exist in the first area 101. However, actually, the number of second areas is not limited to two, typically a lot of second areas are included, and the shapes thereof are unstable.

The situation as illustrated in FIG. 1 may occur when the communication system that uses the second data communication method is built up later in an environment where the communication system that uses the first data communication method and was made in advance exists. Or, the same situation may occur when the communication system in the second data communication method provides a service that covers a small area.

For example, the first data communication method is Evolution Data Only (EV-DO) of Code Division Multiple Access (CDMA) 2000, and the second data communication method is Worldwide Interoperability for Microwave Access (WiMAX) using Orthogonal Frequency Division Multiplexing Access (OFDMA).

Thus, when the second data communication method is a new method or is a method that covers a small area, there is a lot of cases where the second data communication method is better than the first data communication method in several viewpoints such as the communication speed and the stability. Therefore, the second data communication method has a priority to the first data communication method, and the wireless portable terminal is typically controlled so that, in a situation that the communication in both of the first and second data communication methods can be used, the communication is performed in the second data communication method, and when the communication in the second data communication method is impossible, the communication is performed in the first data communication method.

In other words, the wireless portable terminal performs the communication in the second data communication method in the second area 103a or 103b, and in the first area 101 that is other than the second areas 103a and 103b, the communication in the first data communication method is performed. This embodiment relates to data communication in which packets are transferred.

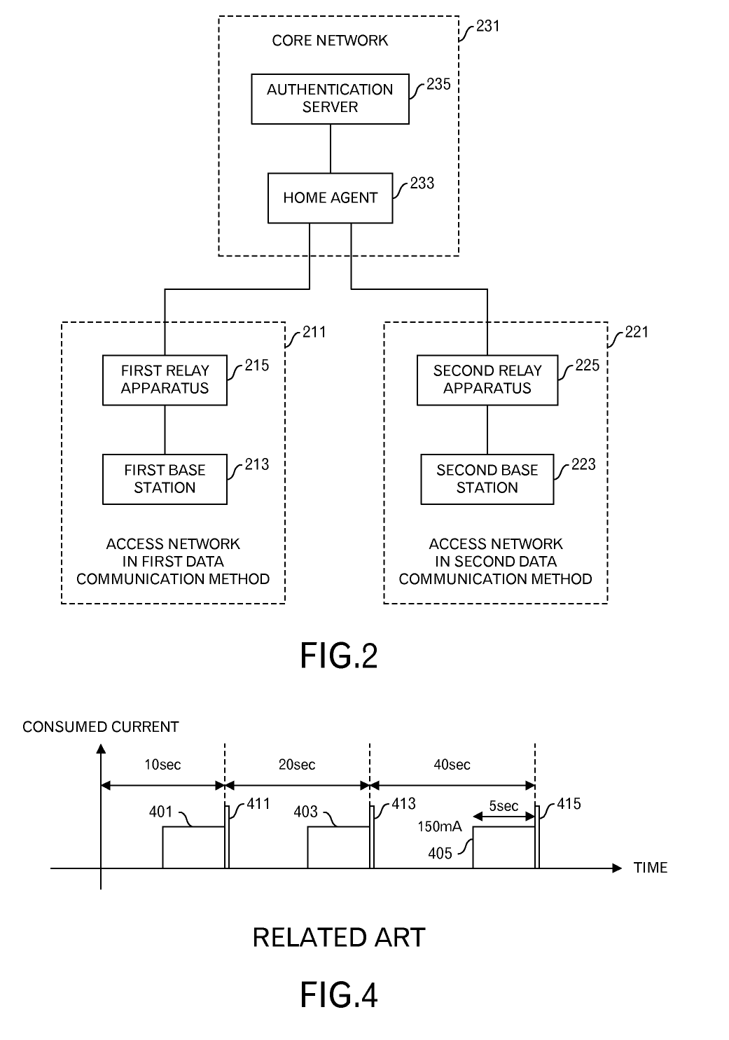

FIG. 2 illustrates a configuration example of a communication system. This communication system has an access network 211 that follows the first data communication method, an access network 221 that follows the second data communication method, and a core network 231. The access network 211 is a network connected when the communication is performed in the first data communication method. The access network 221 is a network connected when the communication is performed in the second data communication method. The core network 231 is a network that functions when the communication is performed in any communication method.

The access network 211 in the first data communication method includes a base station 213 for the first data communication method and a relay apparatus 215 for the first data communication method. The base station 213 is connected in wireless with wireless portable terminals according to the first data communication method to transmit packets to the wireless portable terminals, or receive packets from the wireless portable terminals. The relay apparatus 215 transfers packets according to the first data communication method.

The access network 221 in the second data communication method includes a base station 223 for the second data communication method and a relay apparatus 225 for the second data communication method. The base station 223 is connected in wireless with wireless portable terminals according to the second data communication method to transmit packets to the wireless portable terminals, or receive packets from the wireless portable terminal. The relay apparatus 225 transfers packets according to the second data communication method.

The core network 231 includes a home agent 233 and an authentication server 235. The home agent 233 relays packets between moving wireless portable terminals. The authentication server 235 authenticates a wireless portable terminal.

For example, in the environment as illustrated in FIG. 1, it is presumed that the wireless portable terminal moves from the inside of the second area 103a to the inside of the second area 103b, while performing the data communication. When the wireless portable terminal is within the second area 103a, the data communication is performed in the second data communication method. After that, when the wireless portable terminal moves to the outside of the second area 103a and is at a position between the second area 103a and the second area 103b, the data communication is performed in the first data communication method. At that time, the data communication cannot be made in the second data communication method. Then, when entering into the second area 103b, the data communication can be conducted in the second data communication method again. At this time, the wireless portable terminal that preferentially uses the second data communication method switches the data communication method from the first data communication method to the second data communication method. Thus, the wireless portable terminal can continuously transmit or receive packets while moving.

State transitions when the wireless portable terminal operates as described above will be explained. First, a conventional example that is compared with this embodiment will be explained. FIG. 3 illustrates state transitions in the conventional example. The left side depicts state transitions in the first data communication method, and the right side depicts state transitions in the second data communication method. The wireless portable terminal has a device that controls the first data communication method and a device that controls the second data communication method.

When the wireless portable terminal is within the second area 103a, the device for the first data communication method is in Idle state (S311), and the device for the second data communication method is in data communication (S321).

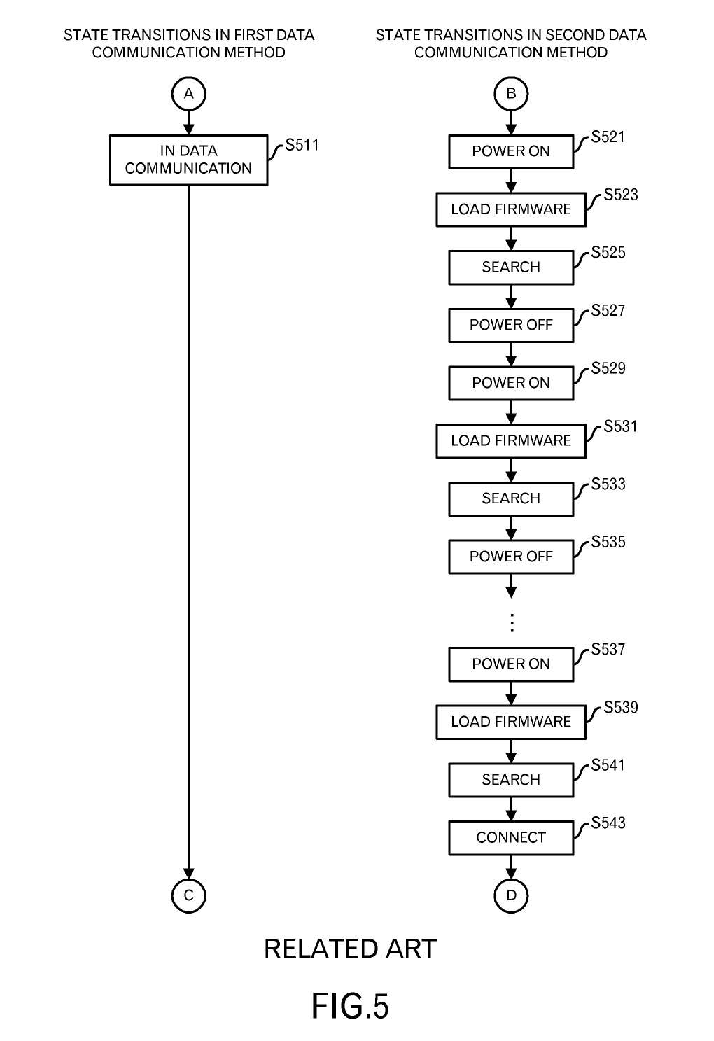

When the wireless portable terminal goes out of the second area 103a, the device for the second data communication method detects that the wireless portable terminal is out of the range of communication for the second data communication method (S323). At a timing illustrated by dashed lines, an operation to change the communication method begins. When being “out of the range of communication” is detected for the second data communication method, Point to Point Protocol (PPP) connection is performed for the first data communication method (S313). However, when the PPP connection is already established, the PPP connection is omitted. Then, the data communication in the first data communication method begins (S315). On the other hand, the power supply is stopped for the device for the second data communication method (S325). The subsequent state transitions will be explained by using FIG. 5. In other words, the state transitions for the first data communication method continue through terminal A to FIG. 5. The state transitions for the second data communication method continue through terminal B to FIG. 5.

Even when the state being “out of the range of communication” for the second data communication method is detected, the wireless portable terminal may return within the range of communication for the second data communication method soon. In order to cope with such a situation, an operation mode for the second data communication method shifts to a search mode. In the search mode, an operation to search for the base stations at predetermined intervals is repeated. When any base station is detected, the data communication in the second data communication method is resumed again.

Here, an outline of the search mode in the conventional example will be explained. FIG. 4 illustrates a consumed power of the device for the second data communication method in the search mode in the conventional example. The current values 411, 413 and 415 represent values of currents consumed during the search. In this example, first search, second search and third search are respectively carried out after 10 seconds, then after 20 seconds, and then after 40 seconds. Then, before the search, the power is supplied, and after the search, the power supply is stopped. Although the illustration is omitted in this figure, the search is performed after 80 seconds, then after 160 seconds, then after 320 seconds, then after 640 seconds, and then after 1800 seconds. After that, the search is performed at intervals of 1800 seconds.

Current values 401, 403 and 405 represent values of currents consumed by the power supply for the device for the second data communication method. The device for the second data communication method performs the initialization in response to the start of the power supply. The initialization includes loading a firmware in the device for the second data communication method, for example. It takes about 5 seconds for the initialization. Furthermore, the current of about 150 mA as the average value is consumed. In this example, the interval of the search gradually increases, however, the interval of the search may be equal.

Next, the state transitions after FIG. 3 will be explained by using FIG. 5. As described above, the left side illustrates the state transitions for the first data communication method, and the right side illustrates the state transitions for the second data communication method. As for the first data communication method, the data communication is being performed (S511). In other words, packets are transmitted or received.

On the other hand, as for the second data communication method, the state is stand by until a predetermined timing, and at the predetermined timing, the power is supplied to the device for the second data communication method (S521). Along with this, the initialization such as loading the firmware is performed (S523), and after that, the search is conducted (S525). As a result of the search, when the base station cannot be detected, the power supply to the device for the second data communication method is made OFF (S527).

After that, the state is standby until the next timing, and at the next timing, the power ON is performed for the device for the second data communication method (S529). As described above, the initialization such as loading the firmware is carried out (S531), and after that, the search is performed (S533). As the result of the search, when the base station is not detected, the power OFF is made for the device for the second data communication method (S535). Thus, the power ON, the initialization such as loading the firmware, the search and the power OFF are repeated.

When the wireless portable terminal goes into the second area 103b in FIG. 1, the base station is detected. In this example, after the power ON (S537) and the initialization such as loading the firmware (S539), the base station is detected in the search (S541). When the base station is detected, connection with the detected base station is established (S543).

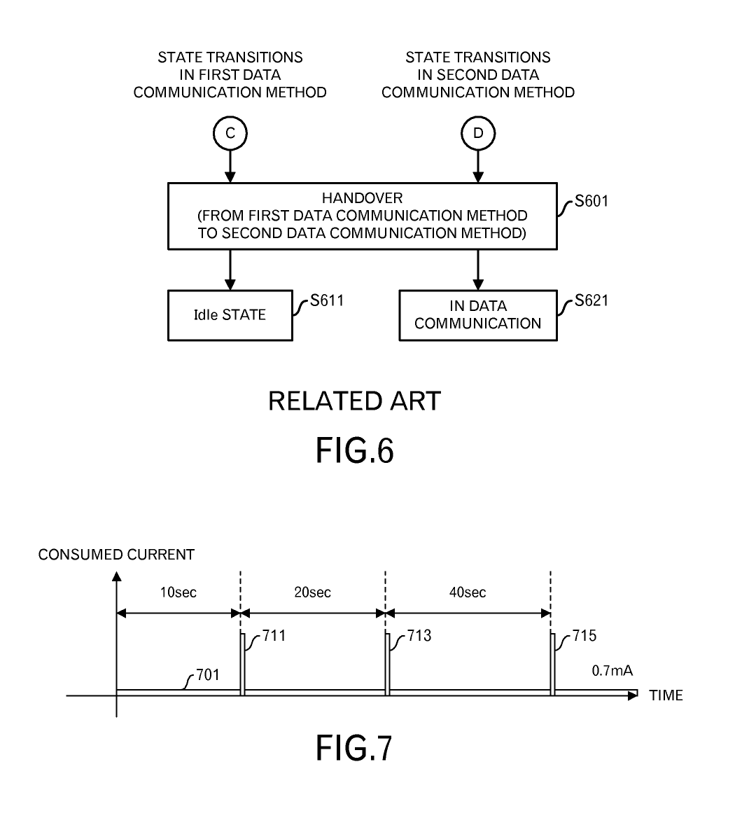

As for the first data communication method, the data communication (S511) continues during the aforementioned processing. The subsequent state transitions are illustrated in FIG. 6. In other words, the state transitions for the first data communication method shift to FIG. 6 through terminal C. The state transitions for the second data communication method shift to FIG. 6 through terminal D.

Shifting to the explanation of FIG. 6, the wireless portable terminal performs handover to switch the data communication method from the first data communication method to the second data communication method (S601). By the handover, the data communication in the second data communication method begins, and the data communication in the first data communication method ends. Then, as for the first data communication method, the state shifts to Idle state (S611), and as for the second data communication method, the state shifts to “in data communication” (S621). Thus, the state returns to the initial state as illustrated in FIG. 3 (S311 and S321).

Thus, in the conventional example, by stopping the power supply in the standby state in the search mode, the power consumption of the device for the second data communication method is suppressed. However, because the power supply is made before the search, a lot of power is consumed each time of the initialization.

In this embodiment, a power consumed for the initialization of the device for the second data communication method is reduced. Specifically, without completely stopping the power supply when shifting to the standby state, the firmware that was loaded onto the memory is held. Then, the power supply is stopped for circuits that do not relate to saving of the memory contents or memories in the device for the second data communication method.

FIG. 7 illustrates a consumed power of the device for the second data communication method in the search mode relating to this embodiment. The current values 711, 713 and 715 represent values of currents consumed during the search operations. In this example, the first search, second search and third search are performed after 10 seconds, then after 20 seconds, and then after 40 seconds. Although additional searches are omitted in the figure, the search is performed after 80 seconds, then after 160 seconds, then after 320 seconds, then after 640 seconds and then after 1800 seconds. After that, the search is repeated at intervals of 1800-seconds. Then, after a predetermined period (in this example, 15 minutes) elapsed, a method that is similar to the conventional example, in which the power is supplied before the search while waiting in the state that the power supply is stopped as described for FIG. 4, is employed.

The current value 701 represents the consumed current due to the operation to keep the firmware that was loaded onto the memory. The consumed current due to the operation to keep the firmware is about 0.7 mA. The search mode relating to this embodiment does not cause any current due to the initialization.

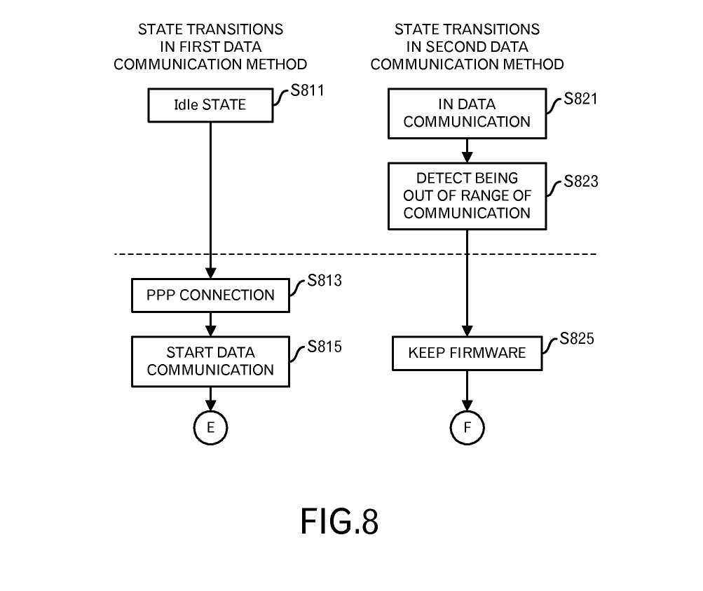

Next, state transitions of the wireless portable terminal in this embodiment will be explained by using FIGS. 8 to 10. Similarly to FIG. 3 and the like, the left side illustrates the state transitions for the first data communication method, and the right side illustrates the state transitions for the second data communication method.

When the wireless portable terminal is within the second area 103a, similarly to S311 and S321 illustrated in FIG. 3, the state of the device for the first data communication method is Idle state (S811), and the state of the device for the second data communication method is “in data communication” (S821).

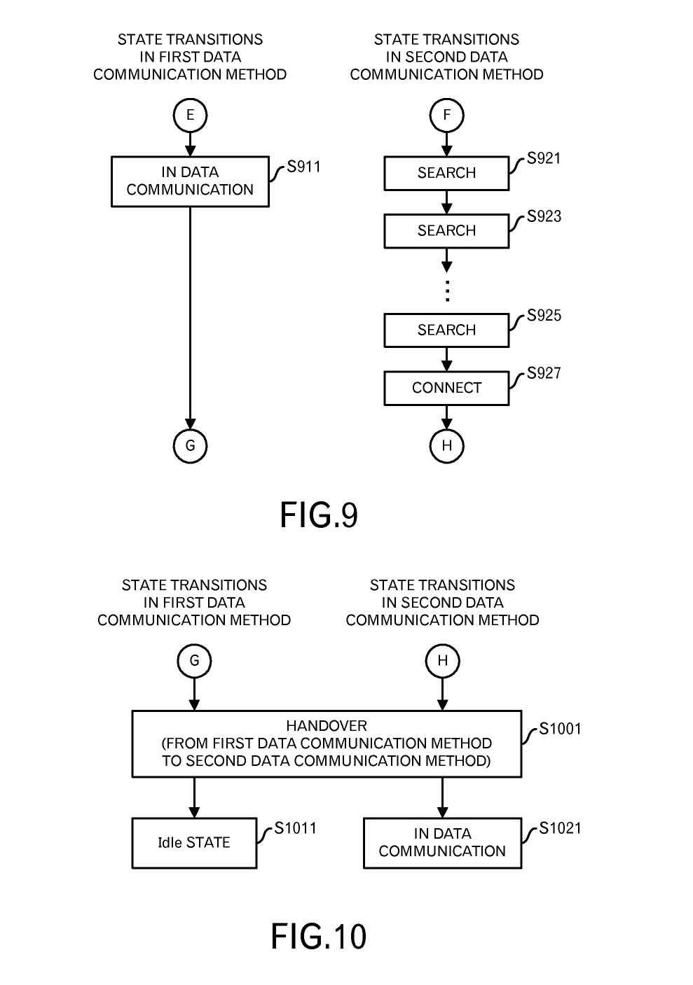

When the wireless portable terminal goes out of the second area 103a, a state of “out of the range of communication” for the second data communication method is detected, similarly to S323 illustrated in FIG. 3 (S823). At the timing illustrated by a dashed line, an operation to change the communication method begins. When the state of “out of the range of communication” for the second data communication method is detected, PPP connection for the first data communication method is conducted similarly to S313 illustrated in FIG. 3 (S813). However, when the PPP connection is already established, the PPP connection is omitted. Then, similarly to S315 illustrated in FIG. 3, the data communication for the first data communication method begins (S815). On the other hand, different from S325 illustrated in FIG. 3, an operation to keep the firmware on the memory is carried out for the second data communication method (S825). The subsequent state transitions will be explained by using FIG. 9. In other words, the state transitions for the first data communication method shifts to FIG. 9 through terminal E. The state transitions for the second data communication method shifts to FIG. 9 through terminal F.

Shifting to the explanation of FIG. 9, as for the first data communication method, the data communication is being performed similarly to S511 illustrated in FIG. 5 (S911). In other words, packets are transmitted or received.

On the other hand, as for the second data communication method, the standby is kept until a predetermined timing, and at the predetermined timing, the search is performed (S921). The search is also performed at the predetermined timing after this (S923 and S925). At that time, different from the state transitions illustrated in FIG. 5, the power ON and the initialization such as loading the firmware are not carried out before the search. Moreover, after the search, the power OFF is not carried out. Then, when the base station is detected, the connection with the detected base station is established (S927).

As for the first data communication method, the data communication continues (S911) during the aforementioned processing. The subsequent state transitions shifts to FIG. 10. In other words, the state transitions for the first data communication method shift to FIG. 10 through terminal G. The state transitions for the second data communication method shift to FIG. 10 through terminal H.

Shifting to the explanation of FIG. 10, the wireless portable terminal performs handover to switch the data communication method from the first data communication method to the second data communication method, similarly to S601 illustrated in FIG. 6 (S1001). By the handover, the data communication in the second data communication method begins, and the data communication in the first data communication method ends. Then, the state for the first data communication method shifts to Idle state (S1011), and the state for the second data communication method shifts to a state “in data communication” (S1021). Thus, the state returns to the initial state illustrated in FIG. 8 (S811 and S821).

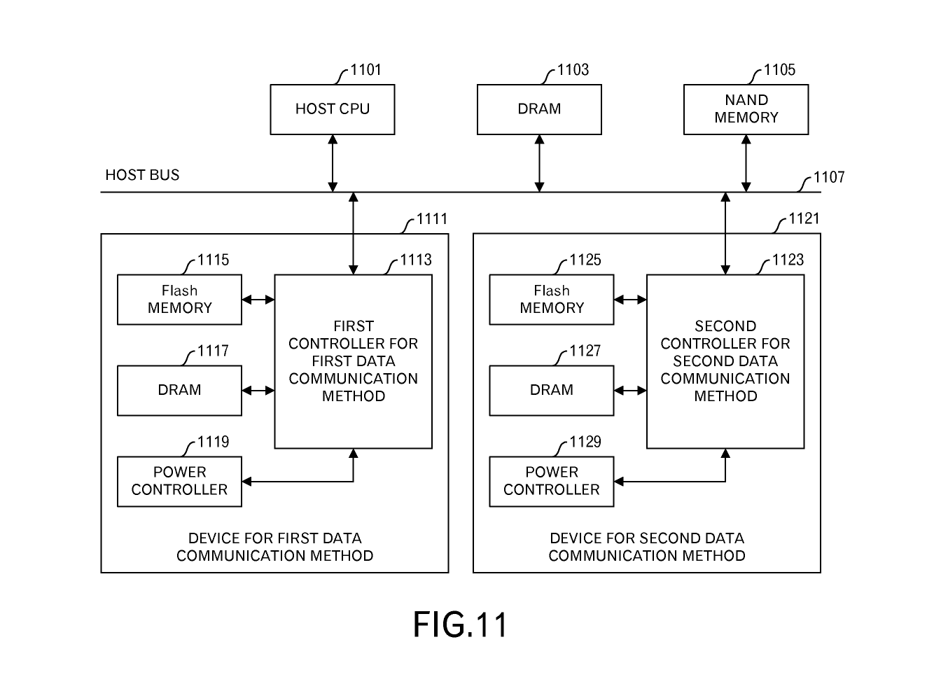

Next, a configuration of the wireless portable terminal will be explained. FIG. 11 illustrates a configuration example of hardware modules relating to the communication control in the wireless portable terminal. The wireless portable terminal includes a host Central Processing Unit (CPU) 1101, Dynamic Random Access Memory (DRAM) 1103, NAND memory 1105, host bus 1107, device 1111 for the first data communication method and device 1121 for the second data communication method. The device 1111 for the first data communication method has a first controller 1113 for the first data communication method, flash memory 1115, DRAM 1117 and power controller 1119. The device 1121 for the second data communication method has a second controller 1123 for the second data communication method, flash memory 1125, DRAM 1127 and power controller 1129. The flash memory 1115 and the flash memory 1125 may be NAND type flash memory or NOR type flash memory. Moreover, instead of the NAND memory 1105, the NOR type flash memory may be employed.

The host CPU 1101, DRAM 1103 and NAND memory 1105 are connected through the host bus 1107. The host CPU 1101 mainly performs arithmetic operations for mode control. The mode control will be explained later. Programs executed by the host CPU 1101 are loaded onto the DRAM 1103. Moreover, the DRAM 1103 is also used to temporarily store data used by the host CPU 1101. The NAND memory 1105 stores programs executed by the host CPU 1101, data used by the host CPU 1101, programs executed by the first controller 1113 for the first data communication method, data used by the first controller 1113 for the first data communication method, programs executed by the second controller 1123 for the second data communication method, data used by the second controller 1123 for the second data communication method and the like.

The device 1111 for the first data communication method is a device that performs control according to the first data communication method. The first controller 1113 for the first data communication method performs a processing to control according to the first data communication method. The first controller 1113 for the first data communication method includes a circuit that performs a processing according to the first data communication method and an arithmetic unit that executes programs to performs a processing according to the first data communication method, for example.

The flash memory 1115 stores a boot loader to load the firmware in the initialization of the device 1111 for the first data communication method from the NAND memory 1105, for example. Programs executed by the first controller 1113 for the first data communication method are loaded to DRAM 1117. Moreover, the DRAM 1117 is used to temporarily store data used by the first controller 1113 for the first data communication method. The power controller 1119 controls the power supply for the device 1111 for the first data communication method. The power controller 1119 controls power supply for the entire of the device 1111 for the first data communication method or for each hardware element such as a circuit included in the device 1111 for the first data communication method, memory unit and the like. The first controller 1113 for the first data communication method is connected with the flash memory 1115, DRAM 1117 and power controller 1119 through an internal bus.

The device 1121 for the second data communication method is a device to perform control according to the second data communication method. The second controller 1123 for the second data communication method performs a control processing according to the second data communication method. The second controller 1123 for the second data communication method includes a circuit that performs a processing according to the second data communication method, and an arithmetic unit that executes programs to perform a processing according to the second data communication method. The flash memory 1125 stores a boot loader to load the firmware from the NAND memory 1105 in the initialization of the device 1121 for the second data communication method. Programs executed by the second controller 1123 for the second data communication method is loaded onto the DRAM 1127. Moreover, the DRAM 1127 is used to temporarily store data used by the second controller 1123 for the second data communication method. The power controller 1129 controls the power supply for the device 1121 for the second data communication method. The power controller 1129 controls the power supply for the entire of the device 1121 for the second data communication method or for each of hardware elements such as a circuit included in the device 1121 for the second data communication method and memory unit. The second controller 1123 for the second data communication method is connected through the internal bus to the flash memory 1125, DRAM 1127 and power controller 1129.

When the power is supplied to the device 1121 for the second data communication method, the second controller 1123 for the second data communication method reads the boot loader stored in the flash memory 1125, and performs a loading processing of the firmware by executing the boot loader. Specifically, the firmware stored in the NAND memory 1105 is loaded onto the DRAM 1127. The size of the firmware is about 3 Mbytes, for example.

Also as for the device 1111 for the first data communication method, when the power is supplied to the device 1111 for the first data communication method, the first controller 1113 reads the boot loader stored in the flash memory 1115, and executes the boot loader to perform a loading processing of the firmware. Specifically, the firmware stored in the NAND memory 1105 is loaded onto the DRAM 1117.

Moreover, the host CPU 1101 issues a command to the device 1121 for the second data communication method to cause the second controller 1123 for the second data communication method to perform operations. For example, the commands are a transition instruction to shift the mode to a communication mode, transition instruction to shift the mode to an Idle mode, a search instruction, standby instruction, resume instruction, power ON instruction, power OFF instruction and the like. These commands will be explained later.

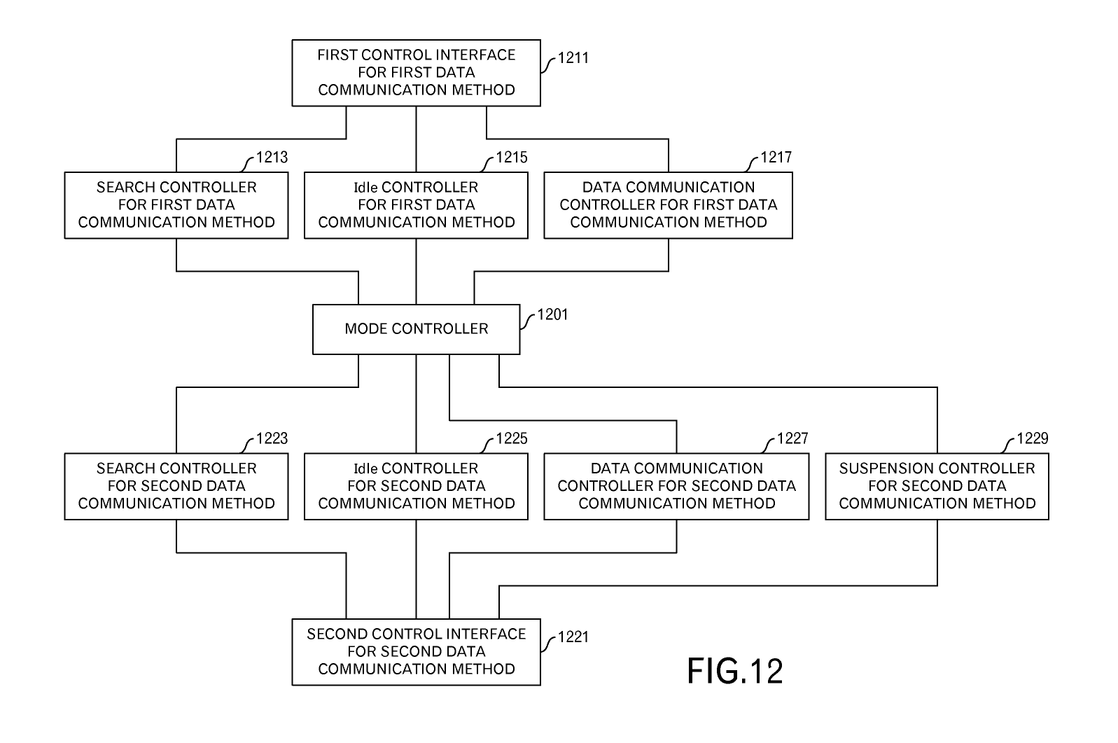

Next, software modules included in the wireless portable terminal will be explained. FIG. 12 illustrates an example of the software modules relating to the communication control. The mode controller 1201 is achieved by executing the software stored in the NAND memory 1105, which is illustrated in FIG. 11, by the host CPU 1101. The software to achieve the mode controller 1201 may be loaded onto the DRAM 1103 from the NAND memory 1105. The mode controller 1201 performs a processing to switch the modes relating to the first and second data communication methods. The mode controller 1201 further achieves part of the processing in each mode. As for both of the first and second data communication methods, the modes include a search mode in which the search is repeated, data communication mode to carry out the data communication and Idle mode in which paging is repeated.

A first control interface 1211 for the first data communication method, search controller 1213 for the first data communication method, Idle controller 1215 for the first data communication method and data communication controller 1217 for the first data communication method are achieved by executing programs included in the firmware for the first data communication method. The firmware is stored in the NAND memory 1105, and executed by the first controller 1113 for the first data communication method.

The first control interface 1211 for the first data communication method is an interface with a transmission signal processing unit and receiving signal processing unit, which will be explained later. The search controller 1213 for the first data communication method performs control for the search in the first data communication method. The search is an operation to search for the base station out of the range of communication. The Idle controller 1215 for the first data communication method performs control during being idle in the first data communication method. Specifically, the Idle controller 1215 for the first data communication method performs control for the paging. The paging is an operation to detect a call from the base station in the range of communication. The data communication controller 1217 for the first data communication method performs control for the data communication in the first data communication method. The data communication is an operation to transmit packets to the base station in the range of communication and receive packets from the base station.

A second control interface 1221 for the second data communication method, search controller 1223 for the second data communication method, Idle controller 1225 for the second data communication method, data communication controller 1227 for the second data communication method and suspension controller 1229 for the second data communication method are achieved by executing programs included in the firmware for the second data communication method. The firmware is stored in the NAND memory 1105 and executed by the second controller 1123 for the second data communication method.

The second control interface 1221 for the second data communication method is an interface with a transmission modem and receiving modem, which will be explained later. The search controller 1223 for the second data communication method performs control for the search in the second data communication method. The Idle controller 1225 for the second data communication method performs control during being idle in the second data communication method. Specifically, the Idle controller 1225 for the second data communication method performs control for the paging. The data communication controller 1227 for the second data communication method performs control for the data communication in the second data communication method. The suspension controller 1229 for the second data communication method suspends the power of the device 1121 for the second data communication method, and further controls the resume.

A part of the modules illustrated in FIG. 12 may be implemented by circuits.

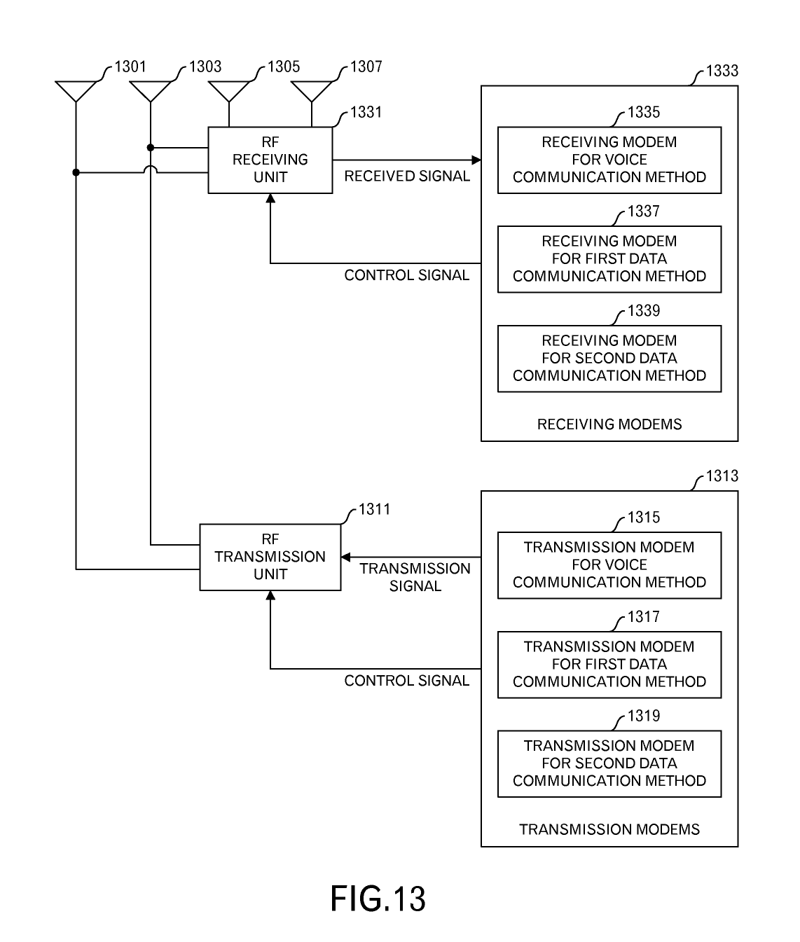

Furthermore, a configuration relating to a signal processing of the wireless portable terminal will be explained by using FIG. 13. The wireless portable terminal has an antenna 1301, antenna 1303, antenna 1305, antenna 1307, Radio Frequency (RF) transmission unit 1311, transmission modems 1313, RF receiving unit 1331 and receiving modems 1333.

The antenna 1301 is an antenna for transmission and receiving in a voice communication method and the first data communication method. The antenna 1303 is an antenna for transmission and receiving in the second data communication method. The antenna 1305 is an antenna for receiving in the voice communication method and the first data communication method. The antenna 1307 is an antenna for receiving in the second data communication method. During the handover, data is received in both of the first and second data communication methods. Therefore, the antennas 1301 and 1303 are used not only for the transmission but also for the receiving.

The RF transmission unit 1311 transmits radio waves for the wireless communication when a transmission signal and control signal are inputted. The RF receiving unit 1331 outputs a received signal when the radio waves for the wireless communication are received and a control signal is inputted.

The transmission modems 1313 includes a transmission modem 1315 for the voice communication method, transmission modem 1317 for the first data communication method and transmission modem 1319 for the second data communication method. The transmission modem 1315 for the voice communication method modulates digital signals to be transmitted in the voice communication method to analog signals. The further explanation of the voice communication is omitted. The transmission modem 1317 for the first data communication method modulates digital signals to be transmitted in the first data communication method to analog signals. The transmission modem 1319 for the second data communication method modulates digital signals to be transmitted in the second data communication method to analog signals.

The receiving modem 1333 includes a receiving modem 1335 for the voice communication method, receiving modem 1337 for the first data communication method and receiving modem 1339 for the second data communication method. The receiving modem 1335 for the voice communication method demodulates analog signals received in the voice communication method to digital signals. The receiving modem 1337 for the first data communication method demodulates analog signals received in the first data communication method to digital signals. The receiving modem 1339 for the second data communication method demodulates analog signals receiving in the second data communication method to digital signals.

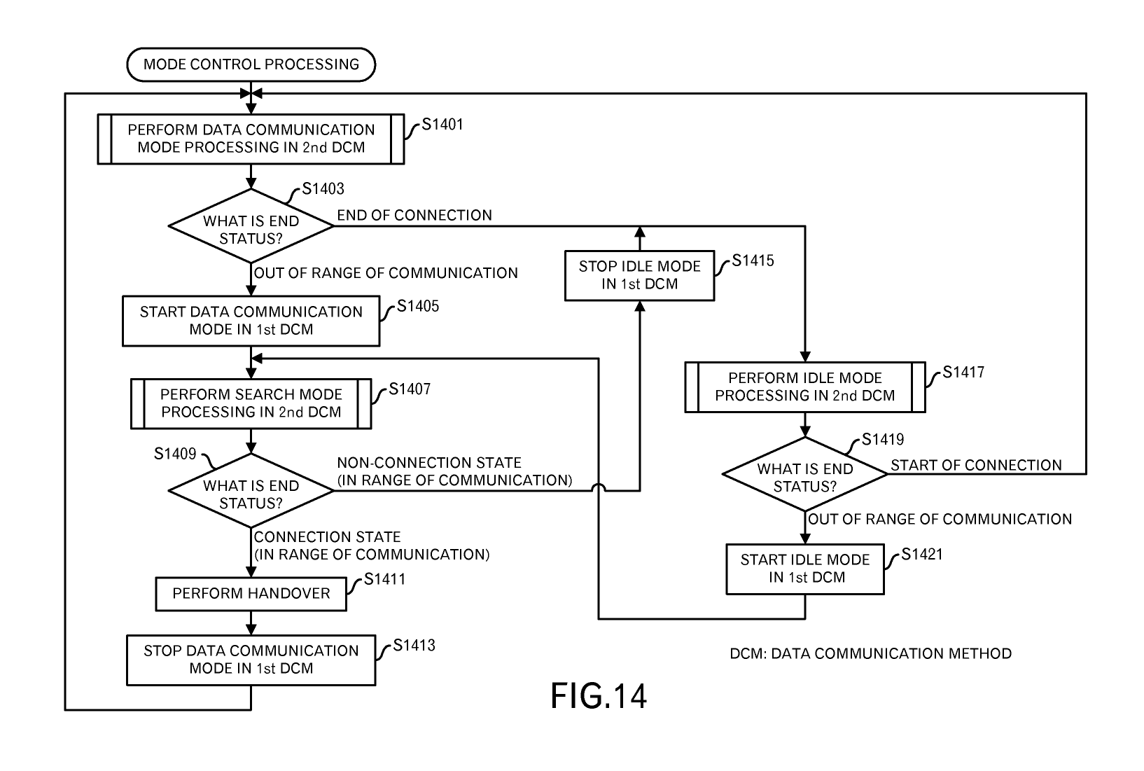

Next, a processing in the wireless portable terminal will be explained. FIG. 14 illustrates an example of a processing flow for a mode control processing. In this example, it is presumed that the mode control processing is executed when a request of the data communication in the second data communication method is received from an application program or operating system. Therefore, first, the mode controller 1201 performs a data communication mode processing in the second data communication method (S1401).

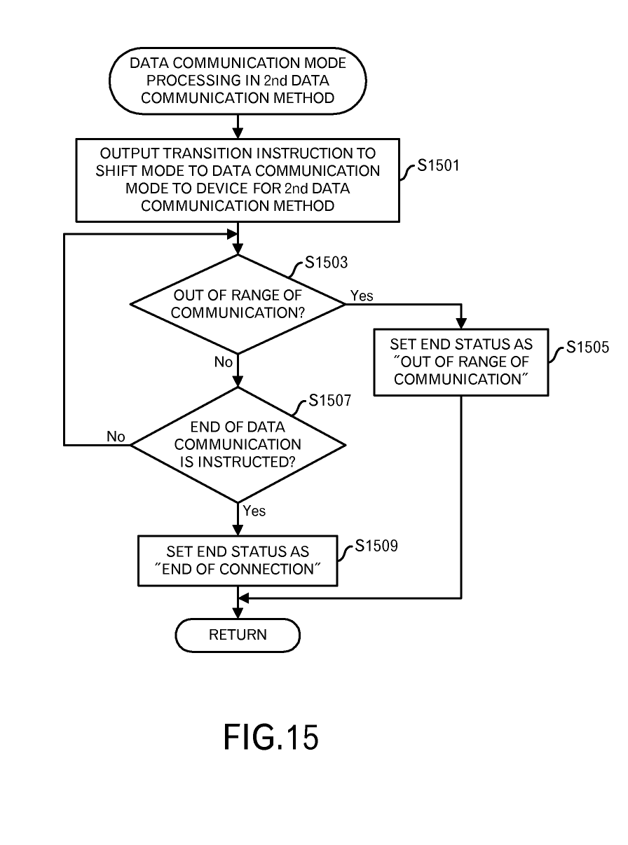

FIG. 15 illustrates an example of a processing flow for the data communication mode processing for the second data communication method. The mode controller 1201 outputs a transition instruction for instructing to shift the mode to a data communication mode to the second controller 1123 for the second data communication method in the device 1121 for the second data communication method (S1501).

When the second controller 1123 for the second data communication method receives the transition instruction to shift the mode to the data communication mode, the second controller 1123 executes a program corresponding to the data communication controller 1227 for the second data communication method in the firmware. Then, the data communication controller 1227 for the second data communication method performs the data communication. The data communication controller 1227 for the second data communication method notifies the mode controller 1201 of being out of the range of communication when being out of the range of communication is detected.

After outputting the transition instruction to shift the mode to the data communication mode, the mode controller 1201 determines whether or not the notification informing the detection of being out of the range of communication was received (S1503). When it is determined that the notification informing the detection of being out of the range of communication was received, the mode controller 1201 sets an end status as “out of the range of communication” (S1505), and the processing ends.

On the other hand, it is determined that the notification informing the detection of being out of the range of communication is not received, the mode controller 1201 determines whether or not an instruction to end the data communication was received (S1507). For example, the instruction to end the data communication may be received from an application program or operating system. When it is determined that the instruction to end the data communication was received, the mode controller 1201 sets the end status as “end of connection” (S1509), and the processing ends.

When it is determined that the instruction to end the data communication is not received, the processing returns to S1503. When the data communication mode processing ends, the processing returns to S1403 illustrated in FIG. 14.

Returning to the explanation of the processing in FIG. 14, the mode controller 1201 determines whether the end status in the data communication mode processing is “out of the range of communication” or “end of connection” (S1403). When it is determined that the end status in the data communication mode processing is “out of the range of communication”, the mode controller 1201 starts the data communication mode in the first data communication method (S1405). The data communication controller 1217 for the first data communication method is activated, and the data communication mode processing by the device 1111 for the first data communication method starts. Thus, when being out of the range of communication is detected for the second data communication method, the data communication method is switched from the second data communication method to the first data communication method.

Then, the mode in the second data communication method is shifted to the search mode. Therefore, the mode controller 1201 performs a search mode processing in the second data communication method (S1407).

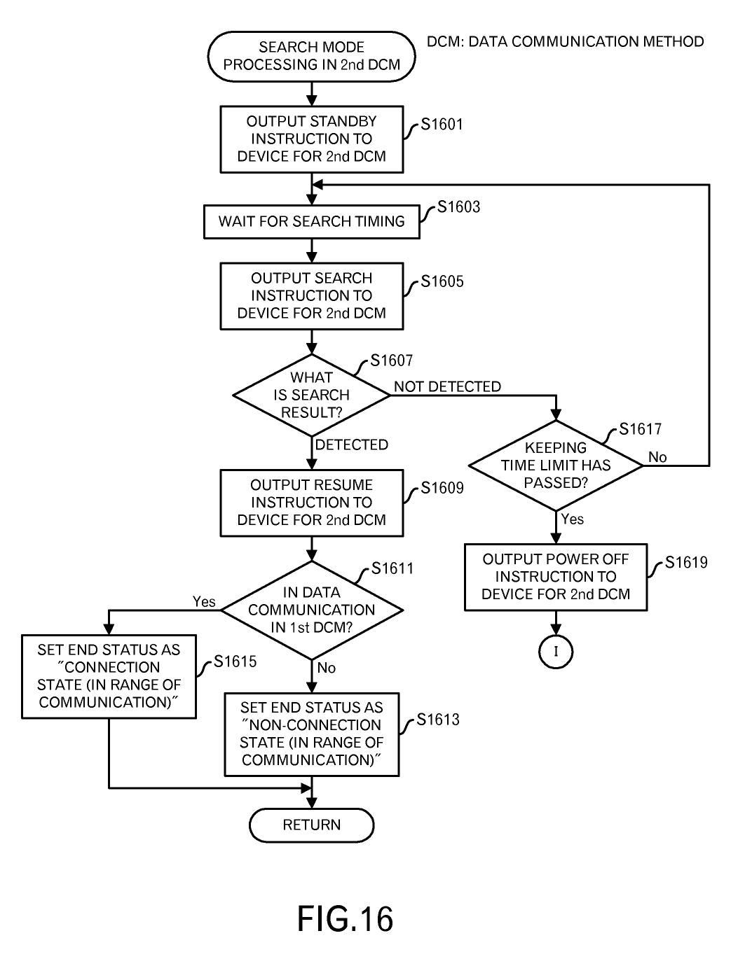

FIG. 16 illustrates an example of a processing flow for the search mode processing in the second data communication method. The mode controller 1201 outputs a power suspension instruction to the second controller 1123 for the second data communication method in the device 1121 for the second data communication method (S1601). When the second controller 1123 for the second data communication method receives the power suspension instruction, the second controller 1123 executes a program corresponding to the suspension controller 1229 for the second data communication method in the firmware. Then, the suspension controller 1229 for the second data communication method executes the power suspension instruction. Specifically, the suspension controller 1229 for the second data communication method outputs an instruction to suspend a part of elements in the device 1121 for the second data communication method to the power controller 1129, and the power controller 1129 suspends the power supply for the circuits and memories, which correspond to the part of the elements, which are designated.

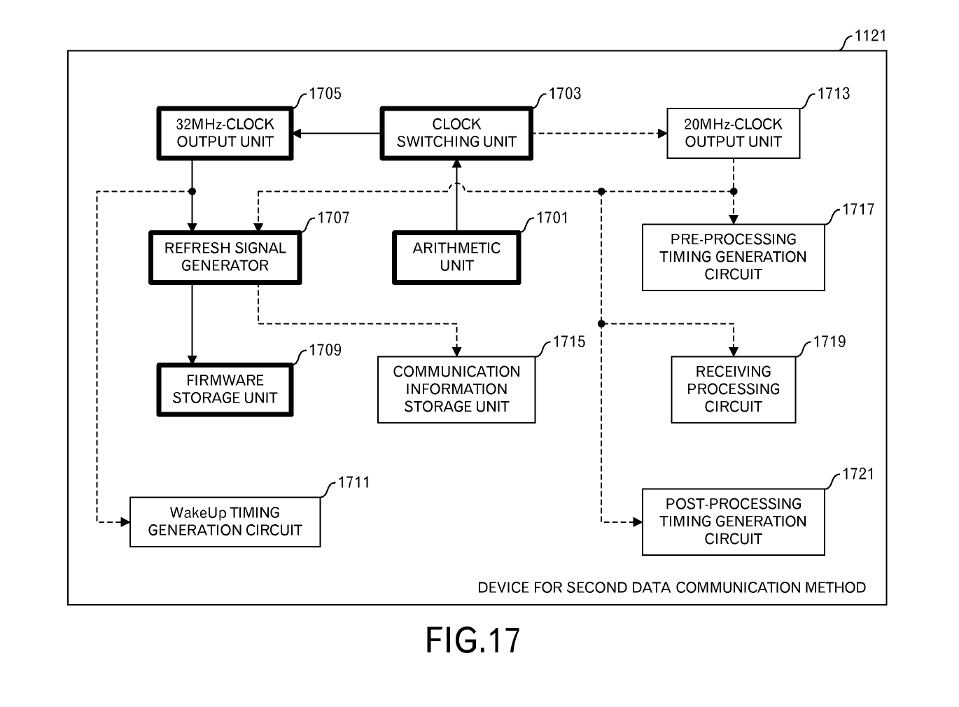

The circuits or memories to be suspended will be explained as an example. FIG. 17 illustrates an example of modules in the devices 1121 for the second data communication method. FIG. 17 illustrates a module associated with keeping of the firmware and a module associated with the paging among modules of the device 1121 for the second data communication method.

The device 1121 for the second data communication method has an arithmetic unit 1701, a clock switching unit 1703, a 32 MHz-clock output unit 1705, a refresh signal generator 1707, a firmware storage unit 1709, a WakeUp timing generation circuit 1711, a 20 MHz-clock output unit 1713, a communication information storage unit 1715, a pre-processing timing generation circuit 1717, a receiving processing circuit 1719 and a post-processing timing generation circuit 1721.

The arithmetic unit 1701 performs a keeping operation of the firmware and an operation for the paging by executing programs in the firmware. The arithmetic unit 1701 is included in the second controller 1123 for the second data communication method, which is illustrated in FIG. 11. The clock switching unit 1703 switches the clock between 32 MHz and 20 MHz. The clock switching unit 1703 is included in the second controller 1123 for the second data communication method, which is illustrated in FIG. 11.

In the keeping operation of the firmware, the clock switching unit 1703 invokes the 32 MHz-clock output unit 1705 to output 32 MHz clock, and stops the 20 MHz-clock output unit 1713. The 32 MHz-clock output unit 1705 outputs the 32 MHz clock. The 32 MHz-clock output unit 1705 is included in the second controller 1123 for the second data communication method, which is illustrated in FIG. 11. The refresh signal generator 1707 receives the 32 MHz clock or 20 MHz clock to generate a refresh signal. The refresh signal generator 1707 is included in the second controller 1123 for the second data communication method, which is illustrated in FIG. 11. The firmware storage unit 1709 keeps the firmware in response to the refresh signal. The firmware storage unit 1709 is a portion of the DRAM 1127 illustrated in FIG. 11. The WakeUP timing generation circuit 1711 generates a timing signal to start the paging.

In the operation of the paging, the clock switching unit 1703 invokes the 20 MHz-clock output unit 1713, and stops the 32 MHz-clock output unit 1705. The 20 MHz-clock output unit 1713 outputs the 20 MHz clock. The communication information storage unit 1715 stores information other than the firmware. For example, system information of the base stations, parameters concerning the protocols, information concerning the synchronization of the frequency and time and the like are stored. The pre-processing timing generation circuit 1717 generates a timing signal to perform a preprocessing for the paging. The receiving processing circuit 1719 performs a processing to receive a paging message. The post-processing timing generation circuit 1721 generates a timing signal to perform the post-processing for the paging.

In the Idle mode, because the paging is performed in the state where the firmware is kept, the power is supplied to the arithmetic unit 1701, clock switching unit 1703, refresh signal generator 1707, firmware storage unit 1709, WakeUp timing generation circuit 1711, 20 MHz-clock output unit 1713, communication information storage unit 1715, pre-processing timing generation circuit 1717, receiving processing circuit 1719 and post-processing timing generation circuit 1721 to cause them to operate.

On the other hand, in the search mode, the firmware is kept, however, the paging is not carried out. Therefore, the power is supplied to the arithmetic unit 1701, clock switching unit 1703, 32 MHz-clock output unit 1705, refresh signal generator 1707 and firmware storage unit 1709, which are illustrated by thick lines, to operate them. In other words, the WakeUp timing generation circuit 1711, 20 MHz-clock output unit 1713, communication information storage unit 1715, pre-processing timing generation circuit 1717, receiving processing circuit 1719 and post-processing timing generation circuit 1721 are suspended. The suspension controller 1229 for the second data communication method instructs to suspend the power supply to theses circuits and storage unit.

The refresh signal generated in the operation of the paging is generated for the firmware storage unit 1709 and the communication information storage unit 1715. On the other hand, the refresh signal generated by the keeping operation of the firmware is generated for the firmware storage unit 1709.

The firmware stored in the firmware storage unit 1709 may include programs to realize the transmission modem 1319 for the second data communication method and the receiving modem 1339 for the second data communication method, which are illustrated in FIG. 13, in addition to programs to realize the second control interface 1221 for the second data communication method, search controller 1223 for the second data communication method, Idle controller 1225 for the second data communication method, data communication controller 1227 for the second data communication method and suspension controller 1229 for the second data communication method, which are illustrated in FIG. 12. The transmission modem 1319 for the second data communication method and the receiving modem 1339 for the second data communication method may be realized by circuits.

Returning to the explanation of the processing illustrated in FIG. 16, the mode controller 1201 waits for a timing for the search (S1603). The timing of the search is described above by using FIG. 7. At the timing for the search, the mode controller 1201 outputs a search instruction to the second controller 1123 for the second data communication method in the device 1121 for the second data communication method.

When the second controller 1123 for the second data communication method receives the search instruction, the second controller 1123 executes a program corresponding to the search controller 1223 for the second data communication method in the firmware. Then, the search controller 1223 for the second data communication method carries out the search. Namely, the base station included in the communication system for the second data communication method is searched. Then, as the search results, “detected” representing that the base station is detected, or “not detected” representing the base station is not detected is returned to the mode controller 1201.

The mode controller 1201 receives the search result, and determines whether the search result represents “detected” or “not detected” (S1607). When it is determined that the search result is “detected”, the mode controller 1201 outputs a power resume instruction to the second controller 1123 for the second data communication method in the device 1121 for the second data communication method (S1609).

When the second controller 1123 for the second data communication method receives the power resume instruction, the second controller 1123 executes a program corresponding to the suspension controller 1229 for the second data communication method in the firmware. Then, the suspension controller 1229 for the second data communication method executes the power resume instruction. Specifically, the suspension controller 1229 for the second data communication method outputs an instruction to resume the suspended elements to the power controller 1129, and the power controller 1129 resumes the power supply to the circuits and storage units, which correspond to the elements being suspended.

The mode controller 1201 determines whether or not the data communication in the first data communication method is being performed (S1611). When it is determined that the data communication in the first data communication method is not being performed, the mode controller 1201 sets the end status as “non-connection state (in range of the communication)” (S1613). When it is determined that the data communication in the first data commutation method is being performed, the mode controller 1201 sets the end status as “connection state (in range of the communication)” (S1615). Then, the processing returns to S1409 in FIG. 14.

When it is determined at S1607 that the search result is “not detected”, the mode controller 1201 determines whether or not the time arrives at the keeping time limit (S1617). In this example, it is determined whether or not 15 minutes elapsed since the beginning of the search mode processing. When it is determined that the time does not arrive at the keeping time limit, the processing returns to S1603, and the mode controller 1201 waits for the next search timing.

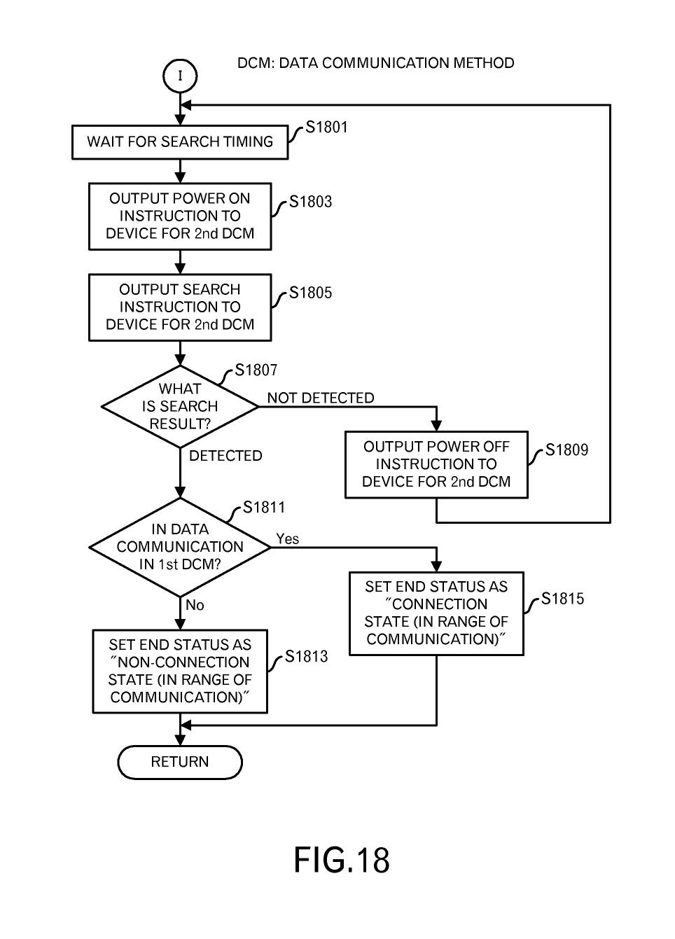

On the other hand, when it is determined that the time arrives at the keeping time limit, the mode controller 1201 outputs the power OFF instruction to the second controller 1123 for the second data communication method in the device 1121 for the second data communication method (S1619). The second controller 1123 for the second data communication method receives the power OFF instruction, and executes the power OFF instruction. Specifically, the second controller 1123 for the second data communication method outputs an instruction to stop the power supply to the device 1121 for the second data communication method to the power controller 1129, and the power controller 1129 stops the power supply. By this instruction to stop the power supply, the power supply even to circuits and storage unit, to which the power supply is not stopped by the suspension instruction, is stopped. After this, the processing shifts to a processing illustrated in FIG. 18 through terminal I.

When a predetermined period elapsed since it is out of the range of the communication, it is assumed that the probability that it will return to the range of the communication soon is low. Therefore, the search is performed after a relatively long period. In this example, the search is performed at intervals of 3 minutes. In addition, the power consumption is suppressed by making the power supply OFF.

A processing after the predetermined period elapsed will be explained by using FIG. 18. The mode controller 1201 waits for the timing of the search (S1801). Then, when arriving at the timing of the search, the mode controller 1201 outputs the power ON instruction to the second controller 1123 for the second data communication method in the device 1121 for the second data communication method (S1803). When the second controller 1123 for the second data communication method receives the power ON instruction, the second controller 1123 executes the power ON instruction. Specifically, the second controller 1123 for the second data communication method outputs an instruction to turn ON of the power of the device 1121 for the second data communication method to the power controller 1129, and the power controller 1129 turns ON of the power. The mode controller 1201 outputs a search instruction to the second controller 1123 for the second data communication method in the device 1121 for the second data communication method (S1805).

When the second controller 1123 for the second data communication method receives the search instruction as described above, the second controller 1123 execute a program corresponding to the search controller 1223 for the second data communication method in the firmware. Then, the search controller 1223 for the second data communication method performs the search. Then, the search controller 1223 outputs, as the search result, “detected” representing the base station is detected, or “not detected” representing the base station is not detected, to the mode controller 1201.

The mode controller 1201 receives the search result, and determines whether the search result is “detected” or “not detected” (S1807). When it is determined that the search result is “not detected”, the mode controller 1201 outputs the power OFF instruction to the second controller 1123 for the second data communication method in the device 1121 for the second data communication method (S1809). Then, the processing returns to S1801, and the mode controller 1201 waits for the next timing of the search.

On the other hand, when it is determined that the search result is “detected”, the mode controller 1201 determines whether or not the data communication by the first data communication method is being performed (S1811). When it is determined that the data communication in the first data communication method is not being performed, the mode controller 1201 sets the end status as “non-connection state (in range of the communication)” (S1813). When it is determined that the data communication in the first data communication method is being performed, the mode controller 1201 sets the end status as “connection state (in range of the communication)” (S1815). Then, the processing returns to S1409 in FIG. 14.

Returning to the explanation of the processing illustrated in FIG. 14, the mode controller 1201 determines whether the end status of the search mode processing is “connection state (in range of the communication)” or “non-connection state (in range of the communication)” (S1409). When the end status of the search mode processing is “connection state (in range of the communication)”, the mode controller 1201 performs a processing of the handover to switch the communication method from the first data communication method to the second data communication method (S1411). Thus, the wireless portable terminal connects with the base station in the second data communication method, and the data communication is prepared. The mode controller 1201 stops the data communication mode in the first data communication method (S1413). At this time, the mode controller 1201 may starts the Idle mode in the first data communication method. Then, the mode controller 1201 performs a data communication mode processing in the second data communication method by returning to S1401.

On the other hand, when it is determined that the end status in the search mode processing is “non-connection state (in range of the communication)”, the mode controller 1201 stops the Idle mode in the first data communication method (S1415). Then, the mode controller 1201 performs the Idle mode processing in the second data communication method (S1417).

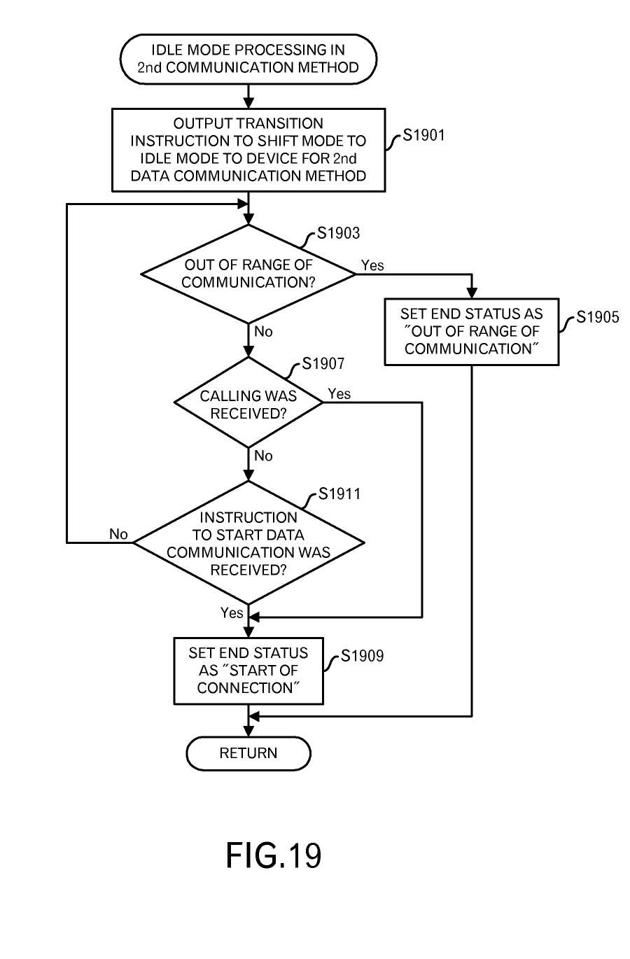

FIG. 19 illustrates an example of a processing flow of the Idle mode processing in the second data communication method. The mode controller 1201 outputs a transition instruction to shift the mode to the Idle mode to the second controller 1123 for the second data communication method in the device 1121 for the second data communication method (S1901).

When the second controller 1123 for the second data communication method receives the transition instruction to shift the mode to the Idle mode, the second controller 1123 executes a program corresponding to the Idle controller 1225 for the second data communication method in the firmware. Then, the Idle controller 1225 for the second data communication method performs the paging. When detecting that its own terminal goes out of the range of communication, the Idle controller 1225 for the second data communication method notifies the mode controller 1201. The Idle controller 1225 for the second data communication method receives a paging message at intervals of 1.28 seconds, for example. When receiving the paging message to that wireless portable communication terminal, the Idle controller 1225 for the second data communication method notifies the mode controller 1201 to that extent. After that, a processing to return to the data communication mode in the first data communication method starts. However, the details are omitted.

After this, the mode controller 1201 determines whether or not the notification that being out of the range of communication is detected was received (S1903). When it is determined that the notification that being out of the range of communication is detected was received, the mode controller 1201 sets the end status as “out of the range of communication” (S1905), and the processing ends.

On the other hand, when it is determined that the notification that being out of the range is detected is not received, the mode controller 1201 determines whether or not the notification of the calling was received from the Idle controller 1225 for the second data communication method (S1907). When it is determined that the notification of the calling was received from the Idle controller 1225 for the second data communication method, the mode controller 1201 sets the end status as “start of connection” (S1909), the processing ends.

On the other hand, when it is determined that the notification of the calling is not received from the Idle controller 1225 for the second data communication method, the mode controller 1201 determines whether or not an instruction to start the data communication was received (S1911). For example, it is assumed that the instruction to start the data communication is received from an application program or operating system. When it is determined that the instruction to start the data communication was received, the mode controller 1201 sets the end status as “start of connection” (S1909), the processing ends.

When it is determined that the instruction to start the data communication is not received, the processing returns to S1903. When the Idle mode processing ends, the processing returns to S1419 illustrated in FIG. 14.

Returning to the explanation of the processing illustrated in FIG. 14, the mode controller 1201 determines whether or not the end status in the Idle mode processing is “out of the range of communication” or “start of connection” (S1419). When it is determined that the end status in the Idle mode processing is “out of the range of communication”, the mode controller 1201 starts the Idle mode in the first data communication method (S1421), the processing shifts to S1407. When it is determined that the end status in the Idle mode processing is “start of connection”, the processing returns to S1401.

In this example, the explanation of the mode switching in the first data communication method and a processing in the mode for the first data communication method is partially omitted. Only part of the processing associated with the mode switching in the second data communication method was explained.

The power consumption will be explained in case where the wireless portable terminal goes into the range of communication again after 10 minutes since the mode shifted to the search mode in the second data communication method in the aforementioned example. In this case, the search was performed six times until the base station is detected. Then, in this conventional art, the load of the firmware consumes 750 m coulomb of the quantity of electricity. Therefore, 4500 m coulomb of the quantity of electricity is consumed, totally. On the other hand, in this embodiment, the current to keep the firmware is 0.7 mA, and 442 m coulomb of the quantity of electricity is consumed for 10 minutes. According to this embodiment, about 90% of the quantity of electricity is reduced compared with the conventional art.

In the aforementioned example, the search is automatically repeated in the search mode. However, the search may be performed in response to an instruction of the application program or operating system. When an instruction from the user is accepted, the search may be performed.

This embodiment may be applied to an onboard terminal. The communication method may be Code Division Multiple Access (CDMA), Time Division Multiple Access (TDMA) or Long Term Evolution (LTE). Moreover, when the communication method is wireless Local Area Network (LAN), for example, the aforementioned base station may be replaced with the access point. Furthermore, this embodiment may be applied not only to the data communication but also to other communication such as the voice communication.

Although one embodiment of this invention was explained, this invention is not limited to this embodiment. For example, the aforementioned functional block diagram may not correspond to a program module configuration.

Moreover, the aforementioned configuration of the storage areas is a mere example. Furthermore, as for the processing flow, the turns of steps may be changed as long as the processing results do not change. Furthermore, the plural steps may be executed in parallel.

The aforementioned embodiment is outlined as follows:

A method for controlling a wireless portable terminal, which relates to this embodiment, includes: (A) determining whether or not the wireless portable terminal is in a wireless communication range of a network, wherein the wireless portable terminal includes a device that includes an arithmetic unit and a volatile memory and controls communication with the network; and (B) upon determining that the wireless portable terminal is not in a wireless communication range of the network, stopping (or suspending) power supply for a portion of the device in a state that a program for causing the arithmetic unit to execute a processing to search a base station or access point in the network is kept in the volatile memory.

According to this method, because the power supply for the portion of the device is stopped when the wireless portable terminal is out of the range of communication, it is possible to suppress the power consumption during the standby of the search for the base station or the like.

Moreover, the aforementioned may further include: reading out and executing, by the arithmetic unit, the program from the volatile memory in a state that the power supply is being stopped.

Thus, loading the program again can be omitted when the search processing is performed. Therefore, it is possible to reduce the power and time required fro the loading of the program.

Moreover, the aforementioned method may further include: restarting the power supply that was stopped, upon detecting that the base station or the access point is detected.

Thus, when the base station or access point is detected, it is possible to communicate with the network (e.g. electrical communication network) soon.

Furthermore, the aforementioned method may further include: stopping power supply for the device, upon detecting that a predetermined period elapsed since the stopping.

Thus, in a state that it is predicted that the standby period is prolonged, it is possible to further reduce the consumed power in the standby state by stopping the power supply for the entire device.

Moreover, the aforementioned method may further include: upon determining that the wireless portable terminal is not in the wireless communication range of the network, connecting with another network.

According to such a processing, even when the communication with the original network restarts after the communication is switched to another network once, it is possible to omit reloading the program. Therefore, it is possible to reduce the consumed power required for the reloading and shorten the time required when the communication with the original network restarts.

Incidentally, it is possible to create a program causing a processor to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A method for controlling a wireless portable terminal, comprising:
determining whether or not the wireless portable terminal is in a wireless communication range of a network, wherein the wireless portable terminal includes a device that includes an arithmetic unit and a volatile memory and controls communication with the network; and
upon determining that the wireless portable terminal is not in a wireless communication range of the network, stopping power supply for a portion of the device in a state that a program for causing the arithmetic unit to execute a processing to search a base station or access point in the network is kept in the volatile memory.

2. The method as set forth in claim 1, further comprising:
reading out and executing, by the arithmetic unit, the program from the volatile memory in a state that the power supply is being stopped.

3. The method as set forth in claim 1, further comprising:
restarting the power supply that was stopped, upon detecting that the base station or the access point is detected.

4. The method as set forth in claim 1, further comprising:
stopping power supply for the device, upon detecting that a predetermined period elapsed since the stopping.

5. The method as set forth in claim 1, further comprising:
upon determining that the wireless portable terminal is not in the wireless communication range of the network, connecting with another network.

6. A control apparatus for controlling communication with a network, comprising:
an arithmetic unit;
a volatile memory;
a determination unit that determines whether or not the control apparatus is in a wireless communication range of the network; and
a stop unit that stops, upon determining that the control apparatus is not in a wireless communication range of the network, power supply for a portion of the control apparatus in a state that a program for causing the arithmetic unit to execute a processing to search a base station or access point in the network is kept in the volatile memory.
